(19) United States
(12) Patent Application Publication
(10) Pub. No.: US 2007/0069800 A1
(43) Pub. Date: Mar. 29, 2007

(54) Negative charge-pump with circuit to eliminate parasitic diode turn-on

(75) Inventors: Yi-Chun Shih, Taipei (TW); Chun Hsiung Hung, Hsinchu City (TW); Kuen-Long Chang, Taipei (TW); Chuan-Ying Yu, Taichung City (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Macronix International Co., Ltd.

(21) Appl. No.: 11/233,901

(22) Filed: Sep. 23, 2005

(51) Int. Cl. G05F 1/10

(52) U.S. Cl. 327/536

(57) ABSTRACT

A negative charge-pump circuit for flash memory includes a well, a pass-gate transistor, a well bias circuit and a negative voltage recovery circuit. The pass-gate transistor has a source, a drain and a gate. The well bias circuit controls the well to remain one of zero biased and reverse biased. The negative voltage recovery circuit is coupled to a negative recovery voltage and coupled to the pass-gate transistor to selectively provide the negative recovery voltage to the pass-gate transistor when the charge-pump circuit is disabled.

### BACKGROUND OF THE INVENTION

The present invention relates to a negative charge-pump, and more particularly, to a negative charge-pump circuit for flash memory having circuitry to eliminate parasitic diode turn-on.

Non-volatile memory (“NVM”) refers to semiconductor memory which is able to continually store information even when the supply of electricity is removed from the device containing such an NVM memory cell. NVM includes Mask Read-Only Memory (Mask ROM), Programmable Read-Only Memory (PROM), Erasable Programmable Read-Only Memory (EPROM) and Electrically Erasable Programmable Read-Only Memory (EEPROM). Typically, NVM can be programmed with data, read and/or erased, and the programmed data can be stored for a long period of time prior to being erased, even as long as ten years.

One very common EEPROM is “flash memory.” Flash memory is a special type of EEPROM that is known in the art. A normal EEPROM only allows one location at a time to be erased or written, whereas flash memory can earse groups of locations at the same time meaning that flash memory can operate at higher effective speeds when the system uses it to read and write to different locations at the same time. Flash memory is non-volatile, which means that it stores information on a silicon chip in a way that does not need power to maintain the information in the chip. In addition, flash memory offers fast read access times and solid-state shock resistance.

Flash memory typically stores information in an array of transistors, commonly referred to as “cells,” each of which traditionally stores one bit of information. Flash memory is based on the Floating-Gate Avalanche-Injection Metal Oxide Semiconductor (FAMOS transistor) which is essentially an n-type Metal Oxide Semiconductor (NMOS) transistor with an additional floating conductor “suspended” by insulating materials between the gate and source/drain terminals. In NMOS transistors, the silicon channel between the source and drain is p-type. When a positive voltage is placed on the gate electrode, it repulses the holes in the p-type material forming a conducting n-type channel and turning the transistor on. A negative voltage turns the NMOS transistor off. With a PMOS transistor, a positive voltage on the gate turns the PMOS transistor off, and a negative voltage turns the PMOS transistor on. NMOS transistors generally switch faster than PMOS transistors.

Programming and/or erase operations for flash memory often require voltages that are higher than the actually available supply voltage. In order to realize the higher voltage, without scaling up the power supply, most memory circuits rely on “charge-pump” circuits. One common charge-pump utilizes a series of diodes and capacitors to “pump-up” or multiply the supply voltage.

FIG. 1A shows a common prior art charge-pump circuit 100 having five stages of diodes D1-D5 and capacitors C1-C5. Of course, there can be additional stages and different size capacitors depending on the required voltage. The output voltage V_{OUT} is a function of the number of stages and can be generally expressed by equation 1 (eqn. 1).
V_{OUT}=(V_{DD}−Vₜ)×N+V_{DD}, where N=the number of stages. eqn. 1
Generally, V_{OUT} increases linearly as the number of stages increases.

FIG. 1B shows another common prior art charge-pump circuit 110. The charge-pump circuit 110 also includes five stages, but instead of diodes D1-D5, the charge-pump circuit 110 includes diode-connected metal oxide semiconductor field effect transistors (MOSFETs) MD1-MD5 and capacitors C1-C5. There can likewise be additional stages and different size capacitors depending on the required voltage. The output voltage of the diode-connected MOSFET charge-pump 110 does not increase linearly as a function of the number of stages because the diode-connected MOSFET charge-pump loses efficiency as the number of stages is increased. As the voltage of each stage increases, the threshold voltage of the diode-connected MOSFET MD1-MD5 increases due to “body effect.”

A complementary MOS or CMOS is an arrangement where an NMOS and PMOS are utilized together to create a complementary device. Since only one of the circuit types is on at any given time, CMOS chips require less power than chips using just one type of transistor which makes them appealing. However, CMOS devices can experience a “latch-up” condition when subjected to transients causing the CMOS to collapse V_{DD} to V_{SS} thereby causing the CMOS device to draw excessive current.

FIG. 1C shows a prior-art four phase negative charge-pump circuit 120 using NMOS transistors XMxE. In this circuit, P-well is biased through the N-type transistors XMxE. Take NMOS XM1E for example, the transistor XM1E keeps the potential on PWI1 to be at most one Vₜ higher than the most negative voltage potential of node DN1 that has ever presented. However, diode turn-on voltage may be lower than an NMOS threshold voltage. This prior art charge-pump 120 suffers from potential latch-up problems. The corresponding simulation waveform is shown in FIG. 3, which shows that well PWI1 may sometimes be higher than the voltage potential of node DN1 and/or node DN2.

It is desirable to provide a negative charge-pump circuit for flash memory having circuitry to eliminate parasitic diode turn-on. Further, it is desirable to provide a negative charge-pump circuit for flash memory that avoids latch-up conditions.

### BRIEF SUMMARY OF THE INVENTION

Briefly stated, the present invention comprises a negative charge-pump circuit for flash memory that includes a well, a pass-gate transistor, a well bias circuit and a negative voltage recovery circuit. The pass-gate transistor has a source, a drain and a gate. The well bias circuit controls the well to remain one of zero biased and reverse biased. The negative voltage recovery circuit is coupled to a negative recovery voltage and coupled to the pass-gate transistor to selectively provide the negative recovery voltage to the pass-gate transistor when the charge-pump circuit is disabled.

The present invention also comprises a negative charge-pump circuit for flash memory. The negative charge-pump includes a plurality of charge-pump cells electrically coupled to each other in series. Each of the plurality of charge-pump cells includes a well, a pass-gate transistor, a well bias circuit and a negative voltage recovery circuit. The pass-gate transistor has a source, a drain and a gate. The well bias circuit controls the well to remain one of zero biased and reverse biased. The negative voltage recovery circuit is coupled to a negative recovery voltage and coupled to the pass-gate transistor to selectively provide the negative recovery voltage to the pass-gate transistor when the charge-pump circuit is disabled.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1A is an electrical schematic diagram of a prior art charge-pump circuit having five stages of diodes and capacitors;

FIG. 1B is an electrical schematic diagram of a prior art charge-pump circuit having five stages of diode-connected metal oxide semiconductor field effect transistors (MOSFETs) and capacitors;

FIG. 1C is an electrical schematic diagram of a prior art charge-pump circuit implemented with n-type metal oxide semiconductor (NMOS) transistors;

FIG. 2A is an electrical schematic diagram of a negative charge-pump circuit in accordance with the preferred embodiment of the present invention;

FIG. 2B is an electrical schematic diagram of one possible detailed implementation of the negative charge-pump circuit of FIG. 2A;

FIG. 3 is a graph showing the output of the negative charge-pump circuit of FIG. 2B;

FIG. 4 is a graph showing the output of the prior art negative charge-pump circuit of FIG. 1C; and

FIG. 5 is a timing diagram for clock signals applied to the negative charge-pump circuit of FIG. 2B.

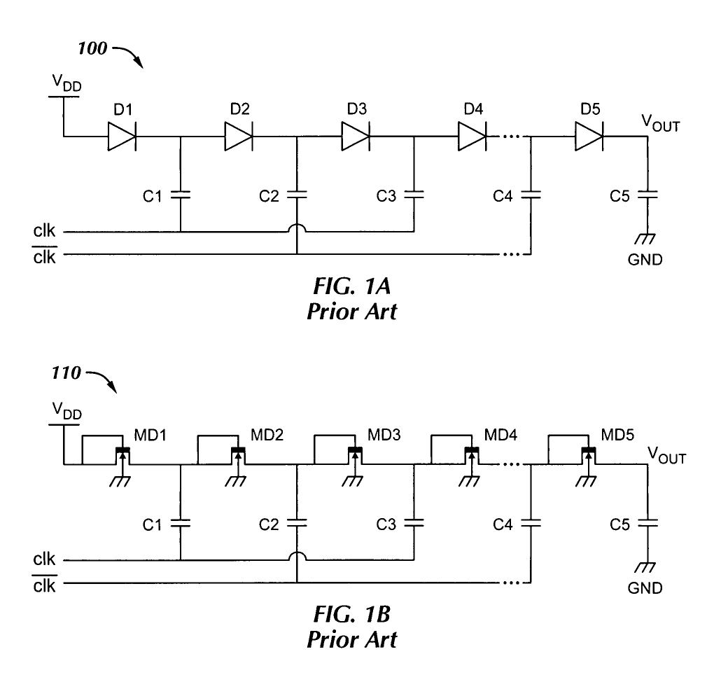

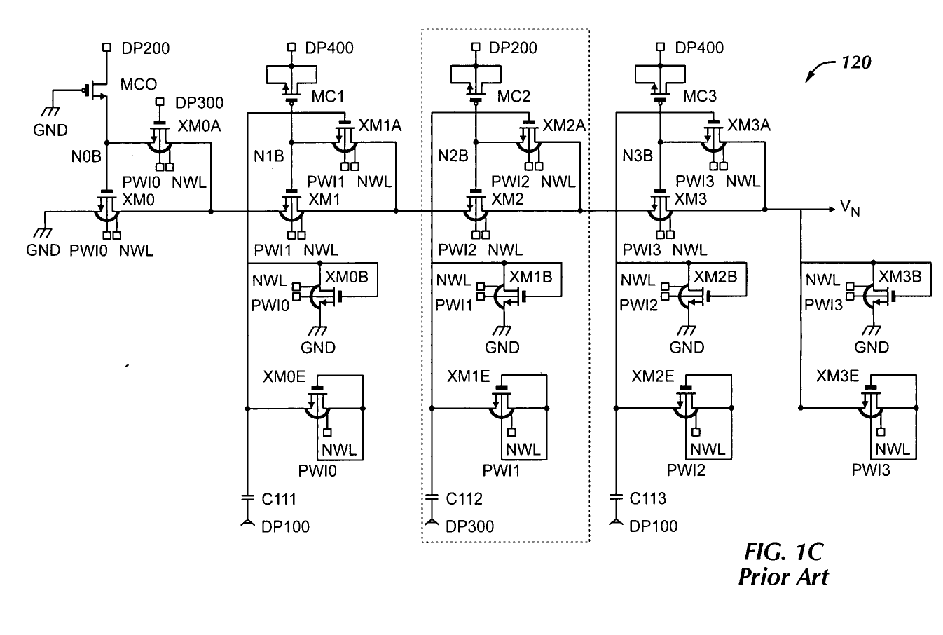

### DETAILED DESCRIPTION OF THE INVENTION

Certain terminology is used in the following description for convenience only and is not limiting. The words “right”, “left”, “lower”, and “upper” designate directions in the drawing to which reference is made. The words “inwardly” and “outwardly” refer direction toward and away from, respectively, the geometric center of the object described and designated parts thereof. The terminology includes the words above specifically mentioned, derivatives thereof and words of similar import. Additionally, the word “a,” as used in the claims and in the corresponding portions of the specification, means “at least one.”

As used herein, reference to conductivity will be limited to the embodiment described. However, those skilled in the art know that p-type conductivity can be switched with n-type conductivity and the device would still be functionally correct (i.e., a first or a second conductivity type). Therefore, where used herein, the reference to n or p can also mean that either n and p or p and n can be substituted therefor. Furthermore, n⁺ and p⁺ refer to heavily doped n and p regions, respectively; n⁺⁺ and p⁺⁺ refer to very heavily doped n and p regions, respectively; n⁻ and p⁻ refer to lightly doped n and p regions, respectively; and n⁻⁻ and p⁻⁻ refer to very lightly doped n and p regions, respectively. However, such relative doping terms should not be construed as limiting.

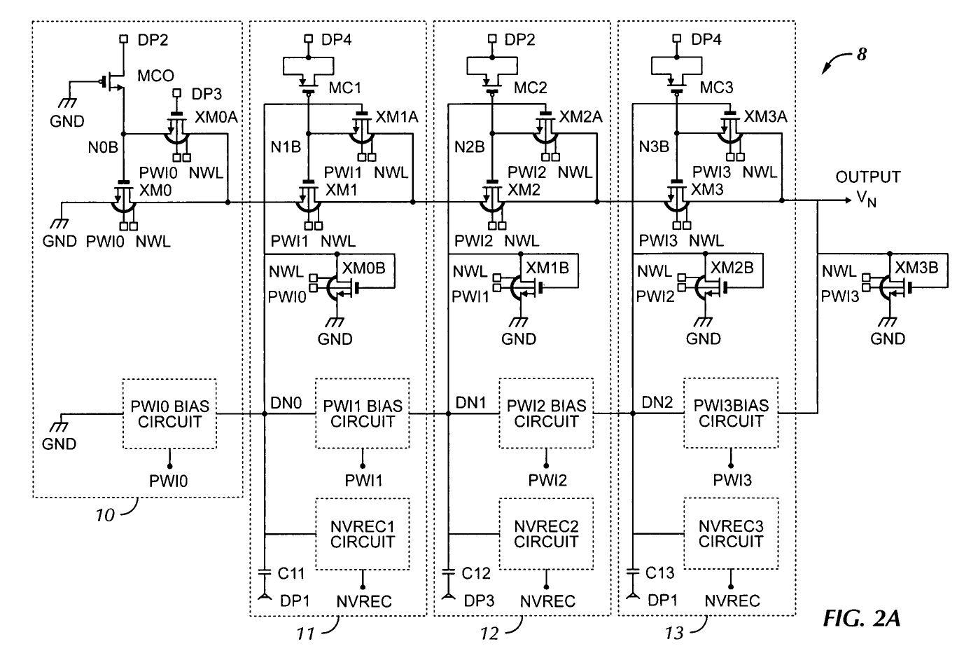

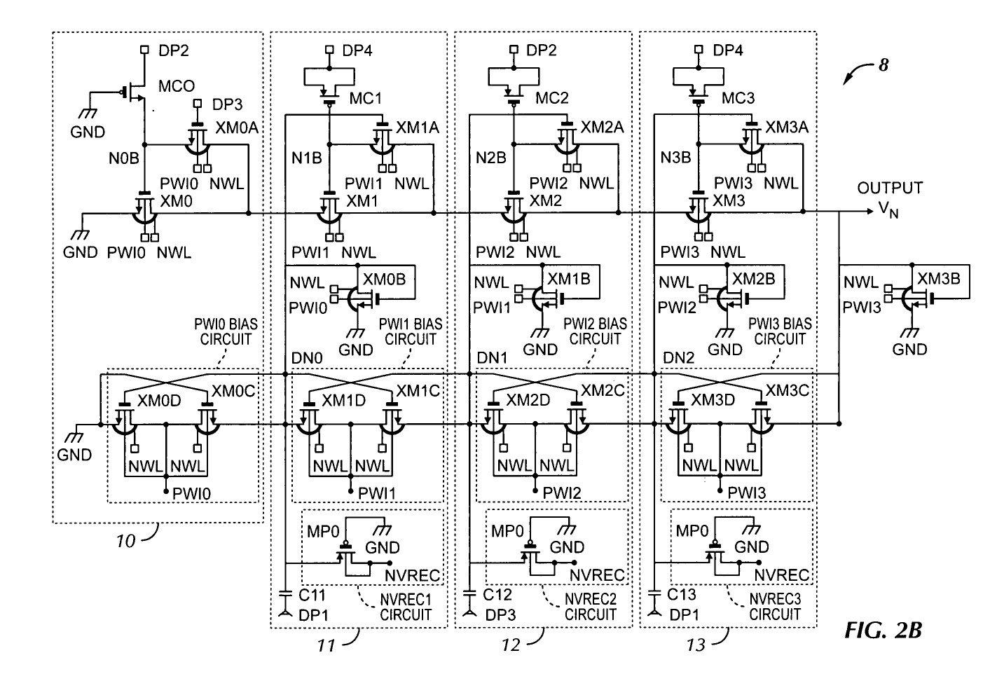

Referring to the drawings in detail, wherein like reference numerals indicate like elements throughout, there is shown in FIG. 2A an electrical schematic diagram of a negative charge-pump circuit 8 in accordance with the preferred embodiment of the present invention.

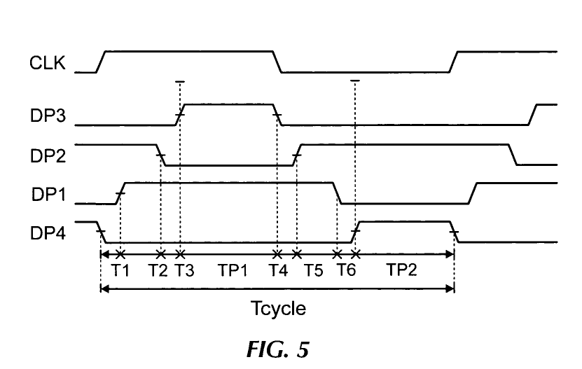

The negative charge-pump circuit 8 includes an initial charge-pump cell 10 and a plurality of charge-pump sub-circuits or charge-pump cells 11, 12, 13. The plurality of charge-pump cells 11-13, connected in series, form the multi-stage charge-pump circuit 8 having an overall output voltage V_{N}. The overall output voltage V_{N} has an increased absolute value compared to the overall input voltage V_{IN} where the input voltage V_{IN} is typically a maximum voltage output V_{DD} (amplitude of clock CLK in FIG. 5) of the circuit power supply (not shown). Similar to the prior art diode-capacitor charge-pump circuits 100, 110, additional pump cells (stages) 11-13 may be utilized in the negative charge-pump circuit 8 depending on the voltage and current requirements for a particular application. Clock signals DP1-DP4 are applied to the charge-pump circuit 8 which drive the various charge-pump cells 11-13 by on-off transitions. The relative timing of clock signals DP1-DP4 is shown in FIG. 5.

The initial charge-pump cell 10 includes a bias circuit PWI0 and pump cells 11-13 each include a bias circuit PWI1-PWI3, respectively. The bias circuits PWI0-PWI3 serve to bias the well of pass-gate transistors XM0-XM3, respectively. The pump cells 11-13 each include a negative voltage recovery circuit NVREC1-NVREC3, respectively. Each of the plurality of charge-pump cells 10-13 includes a well PWI0-PWI3 and a pass-gate transistor XM0-XM3, respectively. Each pass-gate transistor XM0-XM3 has a source, a drain and a gate. Each of the well bias circuits PWI1-PWI3 controls the well PWI0-PWI3 to remain one of zero biased and reverse biased when the charge-pump cell 10-13 is activated. Each negative voltage recovery circuit NVREC1-NVREC3 is coupled to a negative recovery voltage NVREC and coupled to its respective pass-gate transistor XM1-XM3 to selectively provide the negative recovery voltage NVREC to its respective pass-gate transistor XM1-XM3 when the charge-pump cell 11-13 is disabled.

FIG. 2B is one possible detailed implementation of the negative charge-pump circuit 8. The negative charge-pump circuit 8 shows details of the bias circuits PWI0-PWI3 and negative voltage recovery circuits NVREC1-NVREC3.

Initial charge-pump cell 10 includes a voltage supply transistor MC0, a pass-gate transistor XM0, an auxiliary pass-gate transistor XM0A and first and second cross-coupled n-type metal oxide semiconductor (NMOS) transistors XM0D, XM0C. The cross-coupled NMOS transistors XM0D, XM0C form the bias circuit PWI0. The voltage supply transistor MC0 has a source, a drain and a gate. The source of the voltage supply transistor MC0 is coupled to a clock signal DP2, the drain is coupled to a node N0B and the gate is coupled to ground. The initial charge-pump cell 10 includes a p-well PWI0. The pass-gate transistor XM0 and the auxiliary pass-gate transistor XM0A each has a source, a drain and a gate. The source of the pass-gate transistor XM0 is coupled to ground. The source of the auxiliary pass-gate transistor XM0A and the gate XM0 of the pass-gate transistor are coupled to the node N0B. The gate of the drains of both pass-gate transistors XM0, XM0A are coupled to node DN0. The first NMOS auxiliary pass-gate transistor XM0A is coupled to clock signal DP3. transistor XM0D and the second NMOS transistor XM0C each has a source, a drain and a gate. The drain of the second NMOS transistor XM0C is electrically coupled to the drain of the first NMOS transistor XM0D and both drains of the first and second NMOS XM0D, XM0C are coupled to the p-well PWI0. The source of the second NMOS transistor XM0C is coupled to node DN0. The source of the first NMOS transistor XM0D is coupled to ground and the gate of the second NMOS transistor XM0C. The gate of the first NMOS transistor XM0D is coupled to node DN0.

Charge-pump cell 11 includes a voltage supply transistor MC1, a pass-gate transistor XM1, an auxiliary pass-gate transistor XM1A, first and second cross-coupled NMOS transistors XM1D, XM1C, a p-type MOS (PMOS) transistor MP0 and a capacitor C11. The cross-coupled NMOS transistors XM1D, XM1C form the bias circuit PWI1. The voltage supply transistor MC1 has a source, a drain and a gate. The source and drain of the voltage supply transistor MC1 are coupled to a clock signal DP4 and the gate is coupled to node NIB. The voltage supply transistor PMOS MC1 functions as a boost “capacitor” to boost up node NIB. The charge-pump cell 11 includes a p-well PWI1. The pass-gate transistor XM1 and the auxiliary pass-gate transistor XM1A each has a source, a drain and a gate. The source of the pass-gate transistor XM1 is coupled to node DN0. The source of the auxiliary pass-gate transistor XM1A and the gate of the pass-gate transistor XM1 are coupled to the node NIB. The drains of both pass-gate transistors XM1, XM1A are coupled to node DN1. The first NMOS transistor XM1D and the second NMOS transistor XM1C each has a source, a drain and a gate. The drain of the second NMOS transistor XM1C is electrically coupled to the drain of the first NMOS transistor XM1D and both drains of the first and second NMOS XM1D, XM1C are coupled to the p-well PWI1. The source of the second NMOS transistor XM1C is coupled to node DN1. The source of the first NMOS transistor XM1D is coupled to node DN0 and the gate of the second NMOS transistor XM1C. The gate of the first NMOS transistor XM1D is coupled to node DN1. The PMOS transistor MP0 also has a source, a drain and a gate. The source of the PMOS transistor MP0 is coupled to node DN0, the drain and body of the PMOS transistor MP0 are coupled to negative recovery voltage NVREC and the gate of PMOS and the gate of PMOS transistor MP0 is coupled to ground. The NMOS transistors XM1D, XM1C control a well bias of the pass-gate transistor XM1 in the charge-pump cell 11, the p-well of which can be kept equal or lower to its n+ junction in any phase of a clock cycle. Therefore, parasitic junction diodes in the charge-pump cell 11 remain zero biased or reverse biased, and therefore, no latch-up occurs. The PMOS transistor MP0 forms the negative voltage recovery circuit NVREC1. The PMOS transistor MP0 is used in pump cell 11 to recover negative voltage NVREC when disabling the pump cell 11. The NMOS transistors XM1D, XM1C eliminate parasitic diode turn-on in the negative charge-pump cell 11. The first charge-pump cell 11 also includes a diode-connected NMOS XM0B which is used to clamp node DN0.

Charge-pump cell 12 includes a voltage supply transistor MC2, a pass-gate transistor XM2, an auxiliary pass-gate transistor XM2A, first and second cross-coupled NMOS transistors XM2D, XM2C, a PMOS transistor MP1 and a capacitor C12. The cross-coupled NMOS transistors XM2D, XM2C form the bias circuit PWI2. The voltage supply transistor MC2 has a source, a drain and a gate. The source and drain of the voltage supply transistor MC2 are coupled to a clock signal DP2 and the gate is coupled to node N2B. The voltage supply transistor PMOS MC2 functions as a boost “capacitor” to boost up node N2B. The charge-pump cell 12 includes a p-well PWI2. The pass-gate transistor XM2 and the auxiliary pass-gate transistor XM2A each has a source, a drain and a gate. The source of the pass-gate transistor XM2 is coupled to node DN1. The source of the auxiliary pass-gate transistor XM2A and the gate of the pass-gate transistor XM2 are coupled to the node N2B. The drains of both pass-gate transistors XM2, XM2A are coupled to node DN2. The first NMOS transistor XM2D and the second NMOS transistor XM2C each has a source, a drain and a gate. The drain of the second NMOS transistor XM2C is electrically coupled to the drain of the first NMOS transistor XM2D and both drains of the first and second NMOS XM2D, XM2C are coupled to the p-well PWI2. The source of the second NMOS transistor XM2C is coupled to node DN2. The source of the first NMOS transistor XM2D is coupled to node DN1 and the gate of the second NMOS transistor XM2C. The gate of the first NMOS transistor XM2D is coupled to node DN2. The PMOS transistor MP1 also has a source, a drain and a gate. The source of the PMOS transistor MP1 is coupled to node DN1, the drain and body of the PMOS transistor MP1 are coupled to negative recovery voltage NVREC and the gate of PMOS and the gate of PMOS transistor MP1 is coupled to ground. The NMOS transistors XM2D, XM2C control a well bias of the pass-gate transistor XM2 in the charge-pump cell 12, the p-well of which can be kept equal or lower to its n+ junction in any phase of a clock cycle. Therefore, parasitic junction diodes in the charge-pump cell 12 remain zero biased or reverse biased, and therefore, no latch-up occurs. The PMOS transistor MP1 forms the negative voltage recovery circuit NVREC2. The PMOS transistor MP1 is used in charge-pump cell 12 to recover negative voltage NVREC when disabling the charge-pump cell 12. The NMOS transistors XM2D, XM2C eliminate parasitic diode turn-on in the negative charge-pump cell 12. The second charge-pump cell 12 also includes a diode-connected NMOS XM1B which is used to clamp node DN1.

Charge-pump cell 13 includes a voltage supply transistor MC3, a pass-gate transistor 25. XM3, an auxiliary pass-gate transistor XM3A, first and second cross-coupled NMOS transistors XM3D, XM3C, a PMOS transistor MP2 and a capacitor C13. The cross-coupled NMOS transistors XM3D, XM3C form the bias circuit PWI3. The voltage supply transistor MC3 has a source, a drain and a gate. The source and drain of the voltage supply transistor MC3 are coupled to a clock signal DP4 and the gate is coupled to node N3B. The voltage supply transistor PMOS MC3 functions as a boost “capacitor” to boost up node N3B. The charge-pump cell 13 includes a p-well PWI3. The pass-gate transistor XM3 and the auxiliary pass-gate transistor XM3A each has a source, a drain and a gate. The source of the pass-gate transistor XM3 is coupled to node DN2. The source of the auxiliary pass-gate transistor XM3A and the gate of the pass-gate transistor XM3 are coupled to the node N3B. The drains of both pass-gate transistors XM3, XM3A are coupled to an output (output voltage V_{N}). The first NMOS transistor XM3D and the second NMOS transistor XM3C each has a source, a drain and a gate. The drain of the second NMOS transistor XM3C is electrically coupled to the drain of the first NMOS transistor XM3D and both drains of the first and second NMOS XM3D, XM3C are coupled to the p-well PWI3. The source of the second NMOS transistor XM3C is coupled to the output. The source of the first NMOS transistor XM3D is coupled to node DN2 and the gate of the second NMOS transistor XM3C. The gate of the first NMOS transistor XM3D is coupled to the output. The PMOS transistor MP2 also has a source, a drain and a gate. The source of the PMOS transistor MP2 is coupled to node DN2, the drain and body of the PMOS transistor MP2 are coupled to negative recovery voltage NVREC and the gate of PMOS and the gate of PMOS transistor MP2 is coupled to ground. The NMOS transistors XM3D, XM3C control a well bias of the pass-gate transistor XM3 in the charge-pump cell 13, the p-well of which can be kept equal or lower to its n+ junction in any phase of a clock cycle. Therefore, parasitic junction diodes in the charge-pump cell 13 remain zero biased or reverse biased, and therefore, no latch-up occurs. The PMOS transistor MP2 forms the negative voltage recovery circuit NVREC3. The PMOS transistor MP2 is used in charge-pump cell 13 to recover negative voltage NVREC when disabling the charge-pump cell 13. The NMOS transistors XM3D, XM3C eliminate parasitic diode turn-on in the negative charge-pump cell 13. The third charge-pump cell 13 also includes a diode-connected NMOS XM2B which is used to clamp node DN2. A diode-connected NMOS XM3B is used to clamp the output.

The pass-gate transistors XM11-XM13 in combination with the capacitors C11-C13 function as the charge-pump circuitry similar to the prior art diodes D1-D5 and capacitors C1-C5 and diode-connected MOSFET MD1-MD5 and capacitors C1-C5. However, the addition of the NMOS transistors XM1D-XM3D, XM1C-XM3C function to eliminate parasitic diode turn-on and reduces or eliminates latch-up. The PMOS transistors MP0-MP2 are used to relieve high voltage stress on nodes DN0-DN2 when the charge-pump circuit 8 is disabled.

The operation of the charge-pump circuit 8 will be described with respect to the second pump cell 12, but the first and third pump cells 11, 13 function similarly in conjunction with second pump cell 12. PMOS MC2 functions as a boost “capacitor” to boost up node N2B. When clock signal DP2 goes high, node N2B is coupled up and turns on the pass-gate transistor XM2. In contrast, when clock signal DP2 goes low, node N2B is coupled down and turns off pass-gate transistor XM2. The PMOS MC2 can be replaced by any other device that has the equivalent effect as a capacitor. The pass-gate transistor XM2 is used to equalize the potential between nodes DN1 and DN2. Nodes DN1 and DN2 are coupled by clock signals DP3 and DP1, respectively. FIG. 5 shows the relative timing of clock signals DP1-DP4.

Auxiliary pass-gate transistor XM2A pre-charges node N2B with the voltage potential of node DN2 when node DN1 goes high. NMOS XM2C and NMOS XM2D function as a pair of cross-coupled transistors to bias a p-well PWI2, to the lower potential between nodes DN1 and DN2. For example, when the voltage potential of node DN1 is higher than the voltage potential of node DN2, NMOS X2MC turns on and charges p-well PWI2 to the voltage potential of node DN2, while NMOS X2MD remains off. When node the voltage potential of node DN2 is higher than the voltage potential of node DN1, NMOS X2MD connects p-well PWI2 to node DN1 and NMOS X2MC is off. The cross-coupled transistor pair X2MD and X2MC can avoid forward junction turn-on between p-well and NMOS n+ junction. Finally, PMOS MP1 provides a recovery path of node DN1. When the charge-pump circuit 8 is de-activated, negative recovery voltage NVREC is driven to V_{DD} for a certain period of time and node DN1 is charged toward V_{DD}. However, diode-connected NMOS XM1B clamps node DN1 to be at most one Vₜ higher than ground. In operation, the magnitude of the voltage potential at the output is greater than the magnitude of the voltage potential at node DN2, the magnitude of the voltage potential at node DN2 is greater than the magnitude of the voltage potential at node DN1, the magnitude of the voltage potential at node DN1 is greater than the magnitude of the voltage potential at node DN0 and the magnitude of the voltage potential at node DN0 is greater than the overall circuit power supply voltage V_{DD}.

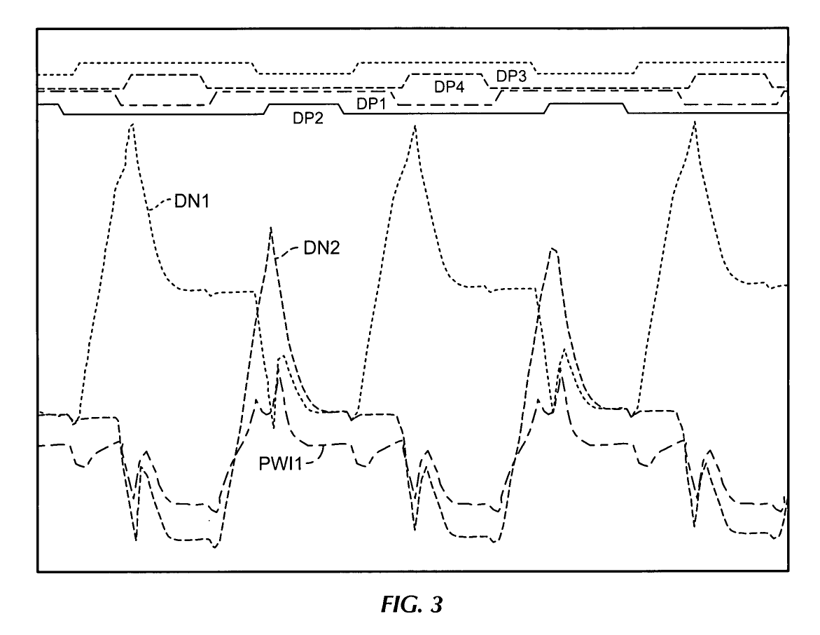

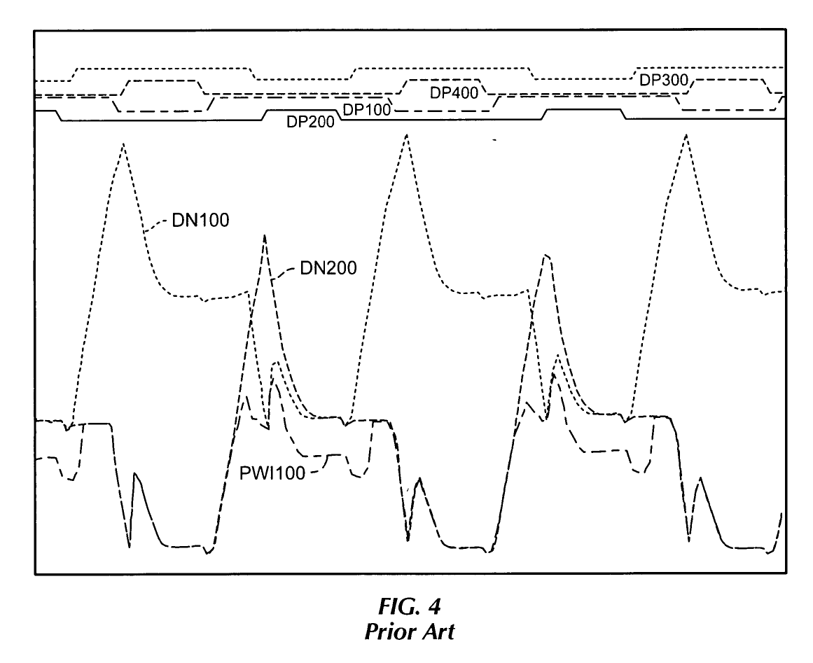

FIG. 3 shows that the voltage potential at p-well PWI1 is always lower than or equal to voltage potentials at nodes DN1 and/or DN2. Thus, the preferred embodiment of the present invention reduces or eliminates latch-up conditions by controlling the well to a more negative bias. In contrast, prior art FIG. 4 shows that p-well PWI1 occasionally exceeds the voltage potential at least at node DN2 which is indicative of a potential latch-up problem.

From the foregoing, it can be seen that the present invention is directed to a negative charge-pump for flash memory having circuitry to eliminate parasitic diode turn-on. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A negative charge-pump circuit for flash memory, the negative charge-pump comprising:
a well;
a pass-gate transistor having a source, a drain and a gate, the gate of the pass-gate transistor being coupled to an input voltage;
a well bias circuit that controls the well to remain one of zero biased and reverse biased; and
a negative voltage recovery circuit coupled to a negative recovery voltage and coupled to the pass-gate transistor to selectively provide the negative recovery voltage to the pass-gate transistor when the charge-pump circuit is disabled.

2. The negative charge-pump circuit according to claim 1, wherein the well bias circuit includes:
a first transistor having a source, a drain and a gate, one of the source and the drain of the first transistor being electrically coupled to the well, the other of the source and the drain of the first transistor being electrically coupled to a first voltage and the gate of the first transistor being electrically coupled to a second voltage; and
a second transistor having a source, a drain and a gate, one of the source and the drain of the second transistor being electrically coupled to the one of the source and the drain of the first transistor not coupled to the well, the other of the source and the drain of the second transistor being electrically coupled to the second voltage and the gate of the second transistor being electrically coupled to the first voltage.

3. The negative charge-pump circuit according to claim 2, wherein the negative voltage recovery circuit includes a third transistor having a source, a drain and a gate, the third transistor being electrically coupled to the negative recovery voltage.

4. The negative charge-pump circuit according to claim 3, wherein the third transistor is a p-type metal oxide semiconductor (PMOS) transistor.

5. The negative charge-pump circuit according to claim 2, wherein the first and second transistors are n-type metal oxide semiconductor (NMOS) transistors, and wherein the first and second NMOS transistors control bias of the p-well.

6. The negative charge-pump circuit according to claim 1, wherein parasitic junction diodes of the negative charge-pump circuit are caused to remain one of zero biased and reverse biased.

7. A negative charge-pump circuit for flash memory, the negative charge-pump comprising:
a plurality of charge-pump cells electrically coupled to each other in series, each of the plurality of charge-pump cells including:
a well;
a pass-gate transistor having a source, a drain and a gate, the gate of the pass-gate transistor being coupled to an input voltage;
a well bias circuit that controls the well to remain one of zero biased and reverse biased; and
a negative voltage recovery circuit coupled to a negative recovery voltage and coupled to the pass-gate transistor to selectively provide the negative recovery voltage to the pass-gate transistor when the charge-pump circuit is disabled.

8. The negative charge-pump circuit according to claim 7, wherein the well bias circuit includes:
a first transistor having a source, a drain and a gate, one of the source and the drain of the first transistor being electrically coupled to the well, the other of the source and the drain of the first transistor being electrically coupled to a first voltage and the gate of the first transistor being electrically coupled to a second voltage; and
a second transistor having a source, a drain and a gate, one of the source and the drain of the second transistor being electrically coupled to the one of the source and the drain of the first transistor not coupled to the well, the other of the source and the drain of the second transistor being electrically coupled to the second voltage and the gate of the second transistor being electrically coupled to the first voltage.

9. The negative charge-pump circuit according to claim 8, wherein the negative voltage recovery circuit includes a third transistor having a source, a drain and a gate, the third transistor being electrically coupled to the negative recovery voltage.

10. The negative charge-pump circuit according to claim 9, wherein the third transistor is a p-type metal oxide semiconductor (PMOS) transistor.

11. The negative charge-pump circuit according to claim 8, wherein the first and second transistors are n-type metal oxide semiconductor (NMOS) transistors, and wherein the first and second NMOS transistors control bias of the p-well.

12. The negative charge-pump circuit according to claim 7, wherein parasitic junction diodes of the negative charge-pump circuit are caused to remain one of zero biased and reverse biased.

13. The negative charge-pump circuit according to claim 7, further comprising:
an input voltage; and
an overall output voltage that has an increased magnitude compared to the input voltage which is a function of the number of the plurality of charge-pump cells.
